(19) United States
(12) Patent Application Publication
(10) Pub. No.: US 2003/0182141 A1
(43) Pub. Date: Sep. 25, 2003

(54) Global IP adminstration process, system & apparatus

(76) Inventors: Albert Wiedemann, Munich (DE); Peter Pirgstaller, Munich (DE); Thomas Zinke, Berlin (DE); Anna Hashuber, Munich (DE); Bernd Milzarek, Heroldsbach (DE)

Correspondence Address: Siemens Corporation, Intellectual Property Department, 186 Wood Avenue South, Iselin, NJ, 08830, US

(21) Appl. No.: 10/261,290

(22) Filed: Sep. 30, 2002

Related U.S. Application Data
(60) Provisional application No. 60/365,894, filed on Mar. 20, 2002.

(51) Int. Cl. G06F 17/60

(52) U.S. Cl. 705/1

(57) ABSTRACT

Global intellectual property (IP) portfolio administration is provided through document administration. A set of statuses are generated that each define at least one action designed to advance the file in a particular jurisdiction. A process flow is developed that incorporates, as elements, statuses from the set relevant to a plurality of the jurisdictions in such a manner that is designed to accomplish a procedure codified by the jurisdictions to advance the file in the particular jurisdiction. A status is assigned from the set of statuses for the file according to the process flow, wherein the document is administered in accordance with the assigned status, thereby administering the global IP portfolio through document administration.

### BACKGROUND

1. Field of the Invention

The present invention relates to an administration process and, more particularly, to a global intellectual property administration process, system & apparatus.

2. Related Information

In the past, there have been attempts to provide systems for tracking the status of a file. In law firms, for example, so called docketing systems that track the status of a file relating to a legal matter are common. In the intellectual property profession, such docketing systems are used to keep track of patent matters, for example. In the example, a particular invention is disclosed to the patent professional and a corresponding file is opened. Typically an internal reference number is assigned to the file and stored in the docketing system. Information such as the patent professional's name and the client's ID are also typically stored in association with the particular file.

However, such docketing systems are used for the purpose of maintaining an accounting of hours spent on a particular file for billing purposes. That is, the system is used simply to store information regarding the number of billable hours spent on the project in order to bill the client for the work performed. Such systems are simple passive billing systems and do not actively take measures to advance the status of the file. While some docketing systems do store critical dates, such as statutory bar dates affecting the date which the patent application must be filed, such dates are manually set and virtually no different than an egg timer. That is, they do not actively take steps to advance the status of the case.

In fact, law firms purposely discourage the use of automated systems to advance the status of the file. For one thing, law firms are wary of malpractice suits which may arise from the action or, perhaps more worrisome, inaction of automated systems. For another, most insurance companies that provide malpractice insurance to such firms would use this reason not to cover any coverage whenever possible. For these reasons, such docketing systems of the prior art taught against taking action to advance the status of the case.

Moreover, such primitive docketing systems do not consider that the file may be affected by the laws of more than one jurisdiction. In the IP world, for example, where technology knows no sovereign boundaries, the protection of such technology is often sought in a plurality of jurisdictions, i.e., countries. This has become more the case in recent times due, in part, to the increased globalisation of the world economy such as the formation of North American Free Trade Agreement (NAFTA), General Agreement on Tariffs & Trade (GATT) and, more recently the European Community (EC) and the introduction of the Euro as currency in the European Union (EU).

In addition, or perhaps as a part of this global oriented economy, the Internet has connected the world together over a world wide network that has stretched the boundaries of global commerce. In the field of IP, for example, patents and patent infringement have now a world wide facet that must be addressed. This is particularly true for Internet or eBusiness Patents that have global reach and effect through the Internet. For that matter, it is typical for patent law suits to be litigated in a multiple of jurisdictions. More than ever, jurisdictional issues, and particularly their inter-relation, must be addressed. To date, such docketing systems do not adequately address the jurisdictional issue and, for that matter, do not provide a relationship between the relevant laws of different countries affecting the particular case.

Nor are such systems global. While there have been, of course, the international conglomerate, the practical reality is that such companies run their regional offices as separate companies. This is true even despite best efforts to harmonize operations of large multiple office companies who may have offices around the world. And so has it been with the prior attempts to harmonize IP in offices located around the world. Thus far, the attempts at world wide docketing have been a hodge podge of applications which are typically separate and not related to another. And, in the instance where the applications may be related, there is no real interaction or harmonization of the documents or actions taken to advance the status of a case. Indeed, until recently there has been no need to do so. Until recently, most jurisdictional legislation affecting IP were by and large unrelated.

Another disadvantage of the prior systems is that they tend to have a narrow focus. Most, if not all, systems do not completely address all of the IP issues relevant to a firm or company. In the typical patent boutique, for example, it is common to have a docketing system that applies only to patents. While larger firms may have included trademark and litigation issues, such systems are not fully capable to administer an IP portfolio. For example, there are licensing matters and third party issues which are typically not dealt with in such prior systems. In addition, such prior systems focussed on legal matters and not on the department as an administration tool. Thus, there has been no system that adequately provides interaction tools between offices, such as sharing of legal news and education, prior art data bases accessible and updatable by the various offices, mail between offices and watch databases that monitor important or dangerous IP that is flagged by members of the offices.

What is needed, therefore, which has not, heretofore, been provided is a system that actually administrates, that is, actively manages the advancement of the status of an IP case. Moreover, what is needed is a system that administrates on a global basis and one that takes into account the various laws of the relevant jurisdictions where IP protection is sought. A system is needed that establishes relationships between the jurisdictions, not merely separate applications with independent processes. What is needed is a truly global administration system that provides true interaction between offices of a world wide company for the purpose of managing all aspects of a global IP portfolio.

### OBJECTS & SUMMARY OF THE INVENTION

An object of the invention is to provide a global administration system.

Another object of the invention is to provide an administration system for an IP portfolio.

Yet another object of the invention is to provide a global IP administration system for an IP portfolio.

It is still another object of the invention to provide administration through document administration.

In accordance with the foregoing objectives, there is provided a global intellectual property (IP) portfolio administration system, method and apparatus. A set of statuses are generated that each define at least one action designed to advance the file in a particular jurisdiction. A process flow is developed that incorporates, as elements, statuses from the set relevant to a plurality of the jurisdictions in such a manner that is designed to accomplish a procedure codified by the jurisdictions to advance the file in the particular jurisdiction. A status is assigned from the set of statuses for the file according to the process flow, wherein the document is administered in accordance with the assigned status, thereby administrating the global IP portfolio through document administration.

### BRIEF DESCRIPTION OF THE DRAWINGS

FIGS. 1a-1c show the masks of the invention;

FIGS. 2a-2c show the GUI of the invention;

FIGS. 3a and 3b and 4-5 show masks of the invention;

FIG. 6 shows a flow diagram of the invention; and

FIGS. 7-15 show process flows of the invention.

### DETAILED DESCRIPTION OF THE PREFERRED EMBODIMENTS

The present invention provides a system that actually administrates, that is, actively manages the advancement of the status of an IP case. Moreover, what is provided is a system that administrates on a global basis and takes into account the various laws of the relevant jurisdictions where IP protection is sought. The system of the present invention establishes relationships between the jurisdictions, and does not merely provide separate applications with independent triggering events. What is provided is a truly global administration system that provides true interaction between offices of a world wide company for the purpose of managing all aspects of a global IP portfolio.

The global administration of intellectual property (IP) of the present invention is provided through the management and administration of documents, herein referred to as document administration. In global IP, documents of various types are associated with a case, any case may relate to any of the various areas of IP. In the present invention, the documents, or the actions regarding the documents, are embued with a status that triggers the events that cause the administration of the IP.

The initial action, or status, of a document is its creation. As will be explained, other actions taken after the document is created further trigger events, according to the assigned status, regarding the administration of the IP. In turn, the triggering events cause actions to be taken which advance the case and cause further triggering events to be set. The documents themselves and the triggering events are set up in the present invention according to the particular type of IP and the respective laws where the IP is to be established. Thus, it will be at once appreciated that the present invention not only creates documents and their respective triggering events for each case, but creates relationships of events between the various jurisdictions in which the particular case is established.

In patents, for example, a particular case may relate to a patent application and the administration thereof begins with the creation of the invention disclosure form, which, in turn, instantiates events that carry out the prosecution of the patent application as provided by the present invention. The documents created and the subsequent events triggered, as defined by the status, will depend partly on the particular jurisdiction in which the patent is prosecuted. It shall be understood that, further, the events set by the invention will depend on and be constructed by a relationship between various jurisdictions where the invention is applied for patent. The particular documents and events triggered, as well as the intricate jurisdictional relationships, will be set forth in more detail.

It should be realized from the outset that the present invention regards not only one area of IP, such as patents, but all areas. What is provided here is a complete global administration system that provides for the administration of IP. These may include, for example, the classic areas of IP, including patents, trademarks and copyrights, but may also incorporate the entire aspect of IP rights, such as trade secrets, licenses, inventor contracts, joint development agreements, litigation and third party matters, etc. In addition, the present invention provides for the inter-departmental cooperation, which may include legal education, watch files, mail and news. Of course, it shall be understood that the invention is not restricted to all IP together, but that the general concepts apply to each individual areas of IP or any combinations thereof. Indeed, the same invention may be utilized for administration in other areas besides IP. In any event, what is provided here is a global administration system.

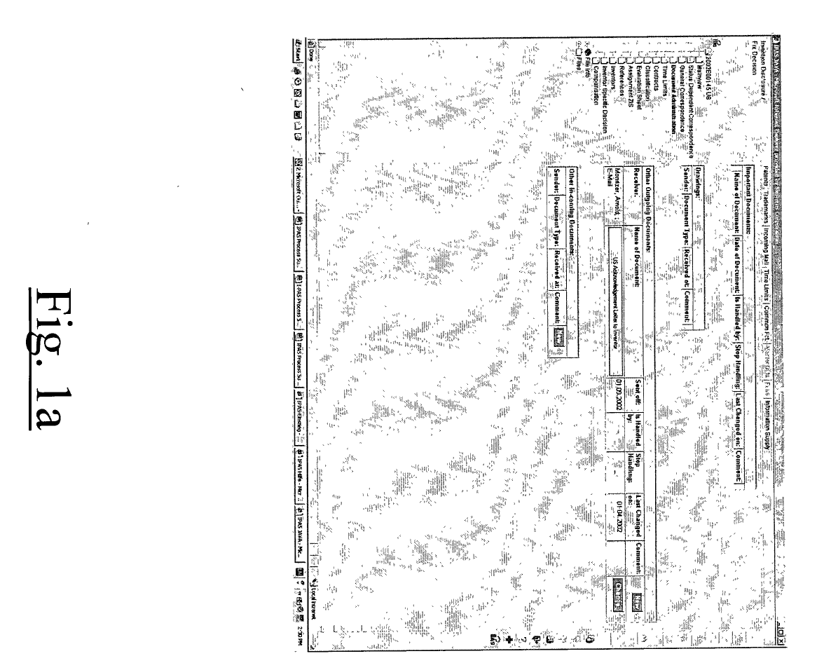

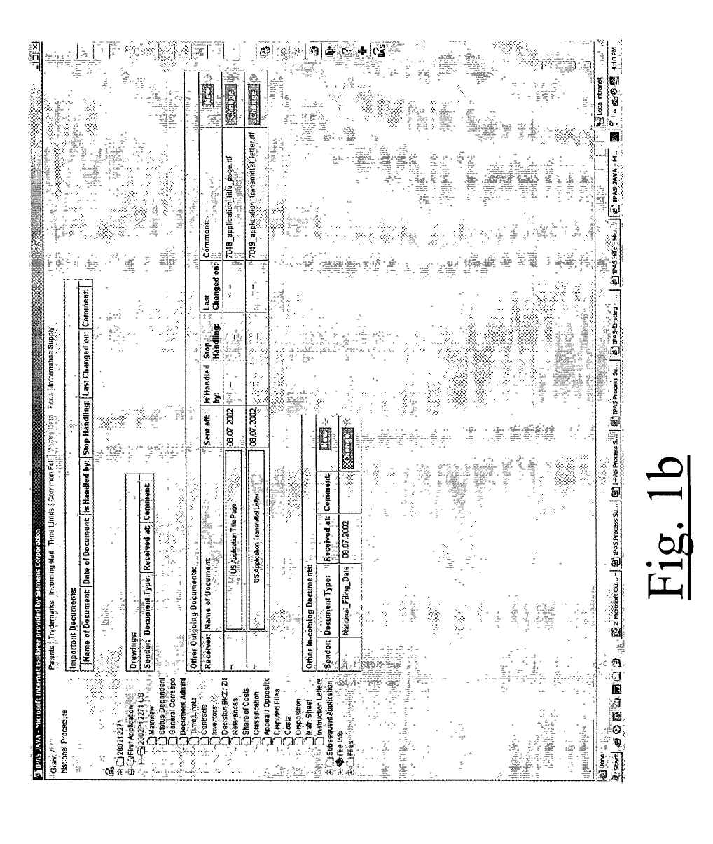

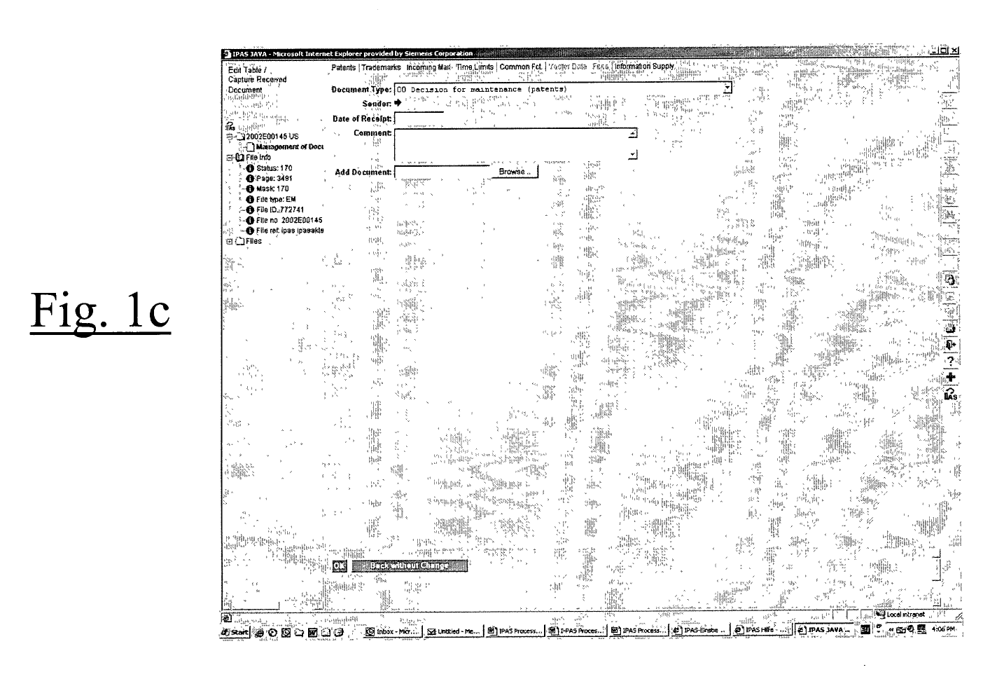

Before turning to the precise details of the invention, it shall be illuminative to consider an example of the manner in which documents are organized for document administration according to the present invention. As shown in FIG. 1a, there is shown the graphical user interface (GUI) 100, explained later in more detail, of the global IP administration system that is the main interface to the user, such as the various IP professionals in one or more departments monitoring and tracking the administration of the cases. Here there is shown the types of Documents according to the present invention.

In the particular aspect shown, the types of documents are separated into three types, shown respectively by three tables. In the first table 102, there are provided important documents. Here, all the documents considered important for a particular case are displayed. For example, a patent application specification would be considered important for a patent case, but perhaps not for a litigation case. In the latter case, the patent itself, not the application, may be considered important. The type of document is recorded by use of, for example, a mask and will later be used to determine how to treat the document of a particular file based on the status of the file. In one variant of the invention, there may be provided areas where information, such as comments, may be entered. Normally, the administration is given the authority to change important information and the normal users are given rights only to change comment information.

There is provided by the second table 104 the list of outgoing documents. In the embodiment shown, sending of the outgoing documents are listed in reverse chronological order according to the date of dispatch set by the system. Confirmation of the dispatch of an outgoing document is also provided by action of a Mailing Button. After clicking the Mailing Button the date of dispatch is confirmed in the system. As with the first table there is provided an intermediate mask, which, amongst other things, provides for the entry of editable remarks.

Once an initial document is created and an associated case is opened, the system will automatically determine and generate which documents need to be sent out in order to further the status of the case. For example, in the case of patents, the creation of the Invention Disclosure document will cause the system to determine and provide for the sending out of the patent application to the relevant countries by a due date, possibly determined by statutory bar date of the relevant patent laws. In each case, the laws will dictate for the most part what documents are to be generated. It is also possible to allow the user to customer tailor the case to decide which documents are outgoing. This may be done instead of, or in addition to, the automatic generation of outgoing documents.

In the third table 106 of FIG. 1a, there are listed the incoming documents. In particular, there is provided an ability to capture incoming documents. For example, creating a new document, and therefore a new file for an invention disclosure, must be provided for. To that end, the present invention instantiates a local word processor where the new document is to be created. In the preferred mode, the invention includes word processor files with pre-established headings and form paragraphs. For example, an office action response document is provided that includes all of the correspondence information, such as the official patent office serial number, the inventor, date of filing, etc. Form paragraphs for introducing the amendments and the remarks, as well as the cost account information, may also be provided. The exact type of document created is selected from these pre-established files from a Messagebox (not shown).

As with the previous tables, the incoming documents are listed in reverse chronological order. In addition, user imported documents can be captured, by clicking on the New File Button which will direct the user to an intermediate mask. A type of document is selected for the imported case and, as mentioned, the type dictates, in view of the status of the case, how the document is handled. As before, remarks can be added and edited by selection of a Change Button. Normally, the input information is assigned automatically and can later be changed by edition. Clicking on the Buttons, as before, causes an intermediate mask to appear in which these editions can be made.

As shown in FIG. 1c, a mask is provided for capturing a received document. As shown, the document type is expressed and the author. In addition, the user is prompted for the receipt date of the document. Also, remarks may be added. In addition, there is provided a button to indicate the file that is to be captured. The author may be automatically imported from the file template. It shall be appreciated that, using the mask information, mistaken capture of an earlier outgoing document is avoided. In order to prevent further error, the invention stores all fields as read only with the exception of the “comments” field.

Thus, the present invention provides various types of documents for administrating an IP portfolio. Of course, any of a number of types of documents may be provided and the means for editing the documents may differ from that precisely described. Suffice here to say that the present invention employs document management to drive the administration of the IP portfolio. Now, the more detailed aspects of the document administration shall be described.

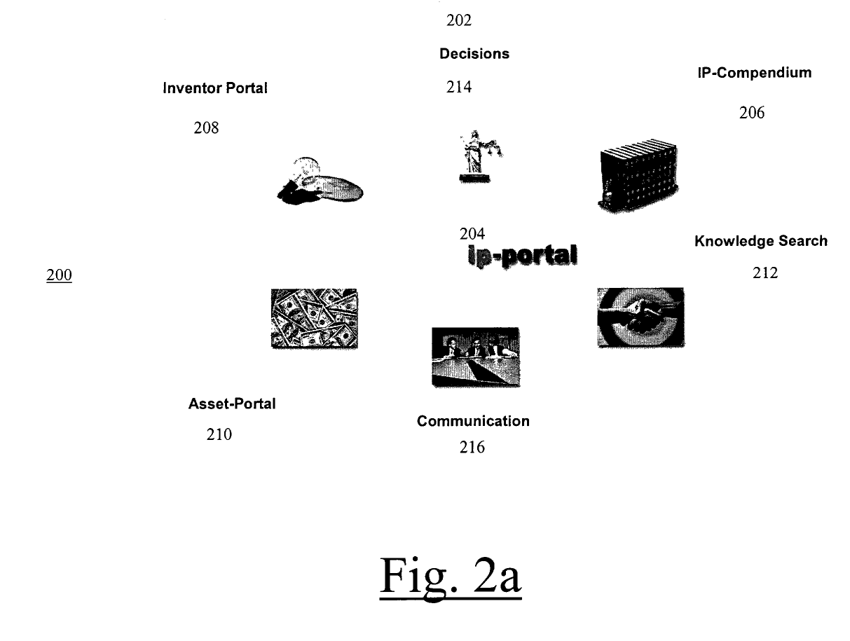

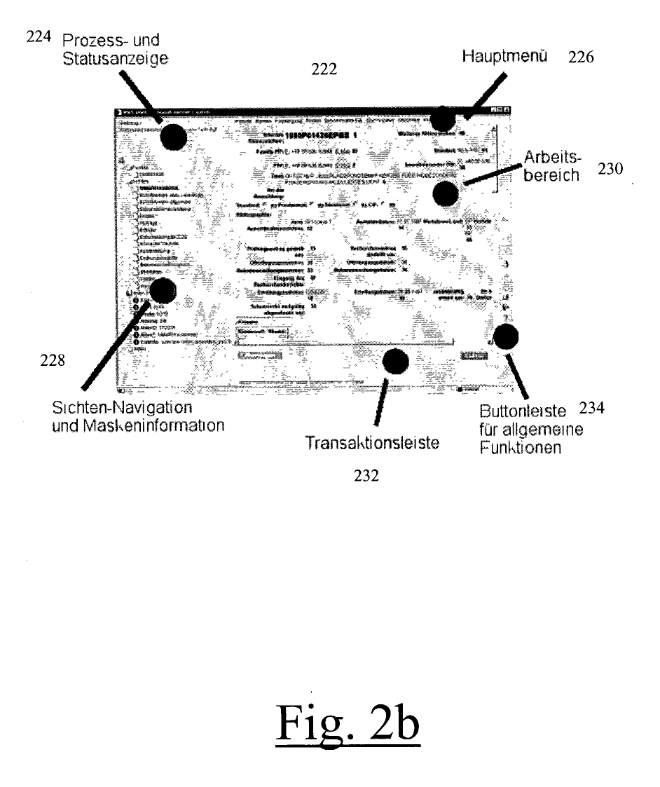

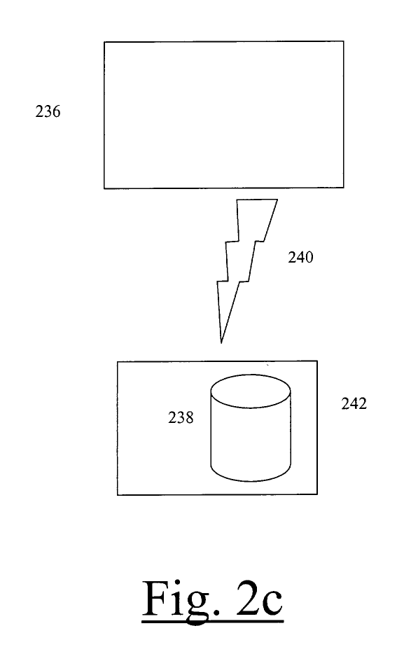

The present invention may be implemented as a software platform 200 as shown in FIG. 2a. A central platform 202 administrates the global IP portfolio. Various other tasks associated with portfolio management may be divided into discrete applications provided either together with or separate from the central platform. For example, the central platform may be provided by a Process Support application 204 which provides for the central administration of the IP portfolio through document administration as herein described. In addition, there may be provided a Portfolio Evaluation application 206 for evaluating the contents of the IP portfolio.

There may also be provided a Portal 208 through which the clients, such as an Inventor, is able to view the status and coordinate with the user to advance the state of the case. There may also be a Managers Portal 210 that is directed to the reporting of the status of the cases from a managerial perspective. There may also be provided a search engine application 212 for executing searches for uncovering state of the art relevant to a particular case. There may further be provided a legal resources application 214 providing a library of legal resources. As shown, there may be an application for providing a communication link to other offices 216. It shall be appreciated that the platform concept illustrated in FIG. 2a is merely one embodiment and, of course, it is within the scope of the invention that the IP administration is provided according to an equivalent structure.

The invention may be provided by the browser 222 shown in FIG. 2b, for example. There may be provided a process and status view 224 that shows the present case and status. There may also be a menu from which the user, depending on the user status and case status, for example, may be able to activate. There may also be a navigation view that provides navigation options, such as, opening views according to the types of process flows available, which will be discussed in further detail. There may also be an information view 230 regarding the selected case. A tool bar 232 may be provided for providing action buttons for manipulating the instant case. A common function bar 234 may be provided that includes common functions, such as search, help, trouble-shooting, etc.

There is shown in FIG. 2c, an example of a graphical user interface (GUI) 236 to be provided by the present invention. It shall be appreciated that the GUI here is a Java GUI, but that any type of GUI may be provided. In any event, the graphical user interface is connected to a central database 242 through a global network 240, such as the Internet. It is preferred to centralize the resources to a global database in order to improve integrity of the data and to minimize incorrect data fallability due to, for example, overlapping entry of the same data. It will be instantly appreciated that use of the global database is advantageous, as well, for security reasons. A global database is simply easier to protect with a common firewall, rather than allowing various databases around the world to fend for their own protection. Of course, the present invention is not solely limited to a central database and, indeed, may employ databases in other offices, for example, for non-critical data. The global database is merely an example of the preferred embodiment.

In order to carry out document management, the present invention provides, in one aspect, a characteristic herein referred to as status-dependent correspondence. In its simplest form, the characteristic relates documents to predetermined actions dependent on a status of the corresponding file. In a more detailed explanation, the function of status-dependent correspondence is to display and administer the items of correspondence relevant to a file in the particular status. That is, the status-dependent correspondence serves to administrate the documents relevant for a document in the respective status.

In the software aspect of the invention, the status may be displayed as a view in a tab bar of the GUI. As an important characteristic, it would be provided in a plurality of process masks, for example. A process mask being a mask, or screen, displayed within a process of a particular file or case.

In status-dependent correspondence, in one aspect, the invention controls the status according to the person(s) associated with the file. Thus, it is important to define a person class. A person class is defined as a group of persons of either natural and/or legal entities, such as law firms or corporations, for example, who are associated with a file. In the invention, the allocation of person classes to a document is status dependent. To explain, for different statuses, different person classes are indicated. In other words, the status of a particular case determines what type of person class applies.

The present invention also provides for a user class. The user class dictates whether the user has access to a document or file. When a patent application is in the prosecution phase, the attorney, for example, would be automatically listed as able to manipulate the file, presumably to write the application. It could be, for example, during this phase, that certain other persons, such as outside counsel or other personnel, are blocked from having access to all or some of the documents in the file to prevent multiple persons from performing overlapping or contradictory editions to the documents.

In the invention, there can be provided attributes for each person class. For example, there can be specified 0 to 5 attributes. In this manner, a type of person class could be indicated as being important during a particular status. In our example, during the prosecution phase, the attorney class could be indicated as a 5, whereas unimportant person classes could be indicated as a lower attribute. The invention would then automatically grant or deny various levels of access, read and/or write, to those having the appropriate attribute. The attributes for a particular case and status can be displayed, for example, in a mask and editable, for example, by the system administrator. In addition, and as will be explained later, each person relevant to the file may receive instruction letters according to their attribute.

The specifics of user authorization control will now be described. In the first instance, there are defined user definitions. The user definitions will define the roles and rights of the particular user. In the preferred embodiment illustrated, the role of each user is defined as follows, however, other user definitions are possible.

Persons in the administration department should be distinguished from other users as they will have certain access rights for monitoring and maintaining the administrative system. In some aspects, these users will have a superior right to access and change data. However, not in all instances. It may be in some aspects of the invention that it is important for the user directly responsible for the case to have access rights to modify documents relating to the file and that the administrative personnel should have no rights to modify such documents. This is due, in part, to the necessity to maintain integrity of the documents such that incongruent editions are not made.

As between persons responsible for the case, there is distinguished between the primary person responsible and a supervisory person. For example, there may be the case where the primary person responsible drives the particular case. Another person in the supervisory role may have control over the payment of the case and should also be corresponded on the case. There may also be a definition for persons who assists the primary and supervisory team. This may be, for example, a secretary responsible for the generation of paper work needed to support the process of the case. There is also provided a personal definition for a person responsible for fee administration. Such is important for paying, in our patent example, the issue and maintenance fees. Another definition may be the contract administrator in cases which involve specialized persons that handle negotiations of the contracts.

For each button, the present invention proscribes roles of the users, or types of users, to be authorized to activate this button are also defined. In this way, authorization assignment means all IPAS users entered can be given access to all files. Assigning the role to the person ensures that only those persons perform transactions whose role has been defined as having authorization for the button. It is possible, for example, to define whether users have full rights, i.e. reading and writing in cases, or whether they are restricted to just “read or write”, or just to individual applications.

Another reason why user definitions are defined is for legal reasons. It is in some jurisdictions that the information relating to the particular case may be privileged according to the laws of that jurisdictions. For that matter, the same jurisdictions oft consider a policy of protecting privileged information as being dispositive on the issue of waiver of privilege. In our patent example, it may not due to allow personnel from other countries to have access to inventions originating, for example, in the U.S. without a foreign filing license. Therefore, in these cases, the present invention grants access to information of the relevant documents based on the person definition of the user and the status of the case. In patent cases that are not yet published, for example, sharing this knowledge with personnel from other countries could be illegal.

As already alluded to, it is also provided to give users different rights according to various specialized processes. In processes, for example, that are unique, perhaps enforced by a minority of jurisdictions, there are provided specialized access rights depending on the status of the case. In addition, the level of access is controlled depending on the level of importance of the user to the case. This means that those persons specializing in a particular area have full rights for the sub-process they need, yet still have “restricted” rights to all other processes.

Now that the invention has provided for the tracking of persons, the next step to providing status-dependent correspondence is to track and maintain the documents. This can be done by special document administration functions such as creating document templates and assigning document types, for example. In practice, assigning documents is achieved by collecting the various documents and determining the various types of documents for a particular IP field. Once the types of documents are determined for a particular type of file, there is assigned the document type to each document of each of the files of the same type. In order to edit the templates there is provided by the invention in one aspect an interface to the local word processor application, such as WinWord. In one example, there could be provided, at the server, templates. The templates are then downloaded to the user machine and the local word processor allows the user to edit the prepared document. This is done purposely to provide a main point of collection of the documents. The documents are then assigned to document types according to the predetermined types indicated by the invention.

The type of document may be any of several various types according to the present invention. The types are predetermined for each type of file. The type, in the patent example, may be an invention disclosure, a patent application, and assignment or declaration form, or any of the various forms needed for furthering the status of the patent application case before the respective patent office. In one aspect, the invention provides that the types of documents include those documents required by the local patent rules of the relevant jurisdiction in which the patent application is prosecuted. Similarly, the types of documents for trademark applications will be dictated somewhat by the documents required for prosecution by the laws of the jurisdiction where the trademark is being applied for. The type of document may indicate the manner in which the document is handled.

The type of document may also dictate, among other things, the selection of post office entrance masks. Here, all classes of persons relevant for the current status are displayed together with the assigned persons. This list is sorted alphabetically by name within the classes of persons. This is done in an effort to predetermine who the sender of an incoming document may be. For example, in the case where each inventor in a particular case are required to complete and return assignment and declaration forms, each of the inventors will be automatically listed by the system in the incoming documents area, with the type of document, i.e., the assignment and declaration, indicated. As each inventor sends in her or his document, the system records this transaction, thereby informing the user which of the inventors still needs to respond.

The type of document and other features of the document may be indicated on a document mask. A master is provided by the invention for various document types and may be edited to custom tailor each document. In the mask, the type of document can be set, for example. In the master, the type of document may be set to a predetermined value. The present invention provides a template with default data automatically inserted therein. Information related to the file, such as the name of the applicant or the reference number of the file, is automatically extracted from a file data base and inserted into the template for each document.

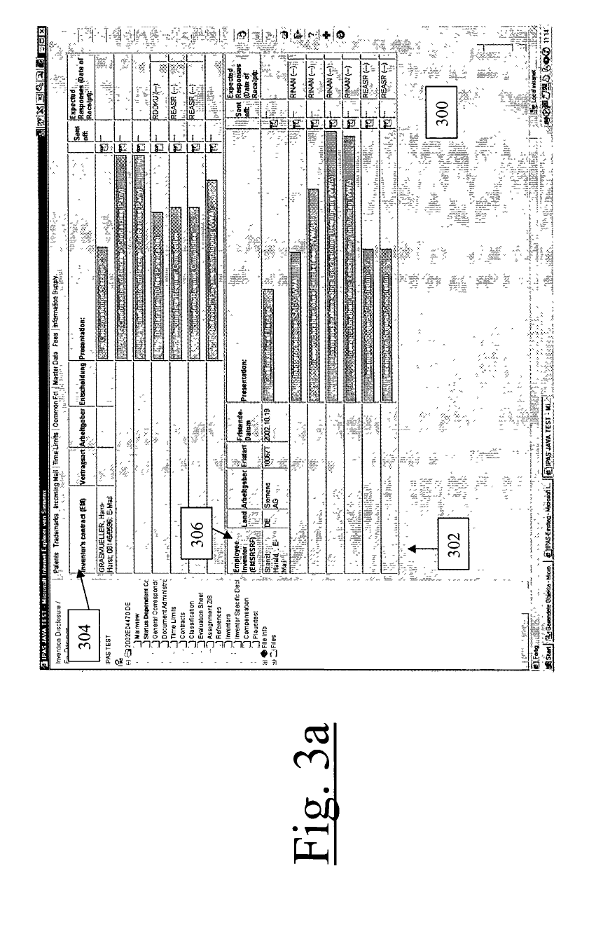

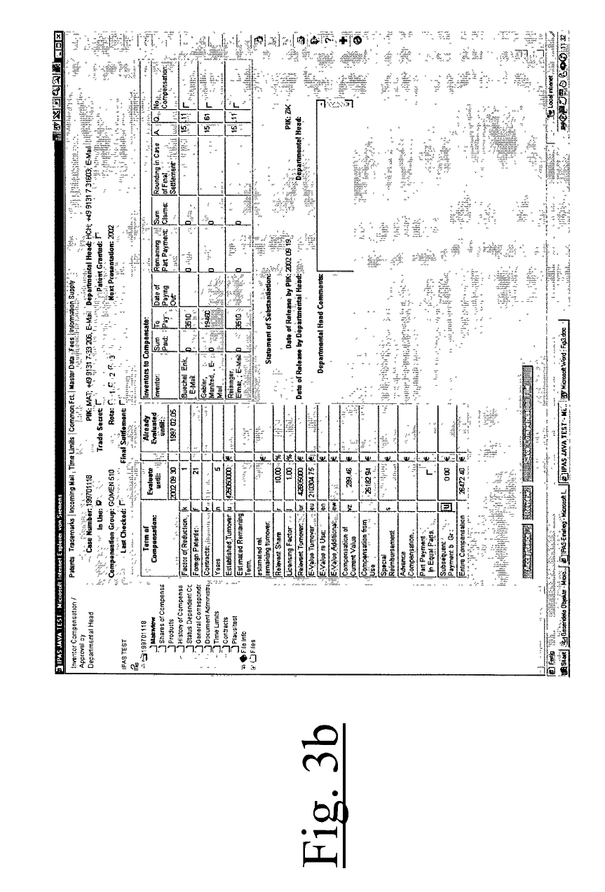

An example of a template 300 of the status-dependent correspondence is shown in FIG. 3a. As will be seen, the person classes 302 are set forth in the first field. Here there is shown corporate inventors 304 and freelance inventors 306 are assigned to the current status.

Other attributes may be provided as well. These may include, in addition to person class, a contract type, period name, period date and contract obligation, for example. The contract type may indicate a particular contract related to the file. This may include, for example, a reimbursement contract between the employee inventor and the employer company. Of course, all other types of contracts may be provided for, such as licenses, mergers or acquisition agreements, agreements of sale or purchase, or joint venture agreements for example. The contract obligation may indicate the details of the contract. The period name may indicate the tag for which the particular period applies and the period date indicates the date which the file is to be concluded. In patents, for example, the period name may be called statutory bar date and the period date indicates the date by which the patent application must be filed.

In the example shown in FIG. 3b, there is shown a type of contract type attribute which indicates a reimbursement contract whereby an inventor is being reimbursed for services. In some countries, such as Germany, laws governing the inventor rights are rigorously enforced. In this and other cases, there is provided by the invention means for handling documents in accordance with the laws of the various legal jurisdictions. Here, there is shown a data field for providing for reimbursement of inventor employees according to the patent law, e.g., Germany. As shown, the reimbursement is indicated as a service provided to the inventor. The invention provides a button for paying the reimbursement. Activating the button causes a new document to be created, the contents of which are predetermined by the invention and provided as a master template. Although the master template provides the default information, the user can, of course, make changes to this document using the template.

As will be later explained, the present invention provides an automated payment mechanism that automatically sends off payment to the contracting party. In the example shown in FIG. 3, there is shown payment of reimbursement to the inventors. When payment is to be made, the user activates the button to instantiate a template for the payment which, when finalized, e.g., saved, automatically activates a series of steps for issuing the payment. Payment may be automatically issued, for example, by automatically sending an instruction to the payment personnel, who is instructed to authorize the payment. Of course, with today's computers payment can be made automatically. Given the desire by most corporate entities to involve an accounting procedure in order to minimize error, the invention described here provides for the former situation.

The present invention provides discrete functions of document management that carry out the administration of the IP portfolio. The important functions will now be described in more detail. Obviously, routine functions provided by the background operating system, for example, opening files and saving documents will not be discussed in detail. Here now is a description of the most relevant functions that support document management. Of course, the present invention is not limited to any particular function described and, of course, may include one or a combination of the functions described.

In the present invention, documents drive the administration of the respective files. As explained, a document has associated therewith triggering events that advance the status of the case. The triggering events are, in the first instance, set forth in advance by the master templates. Thus, upon the creation of a new document a new instantiation of the events for that particular document is created. Therefore, it will now be described how to create a document.

To create a document, the invention first prompts the user to select a template. This is done here by entering a name for the document and clicking on the Create Document button provided in the invention. The invention automatically creates the relevant document by instantiating a new version of the master template selected. In the case of word processor documents, the invention instantiates a new version of a master word processor file. As already explained, for example, there is provided automatic creation of patent office correspondence with boiler plate language already provided. The relevant information relating to the particular file, such as the parties names and relevant dates or reference numbers are inserted into the file automatically. Needless to say, anyone skilled in the art of programming databases will readily know how this is achieved. Other information, such as addressee information which is not necessarily provided by the file information may be added by the inventor. Such information may be relevant for, for example, creating instruction letters to outside counsel.

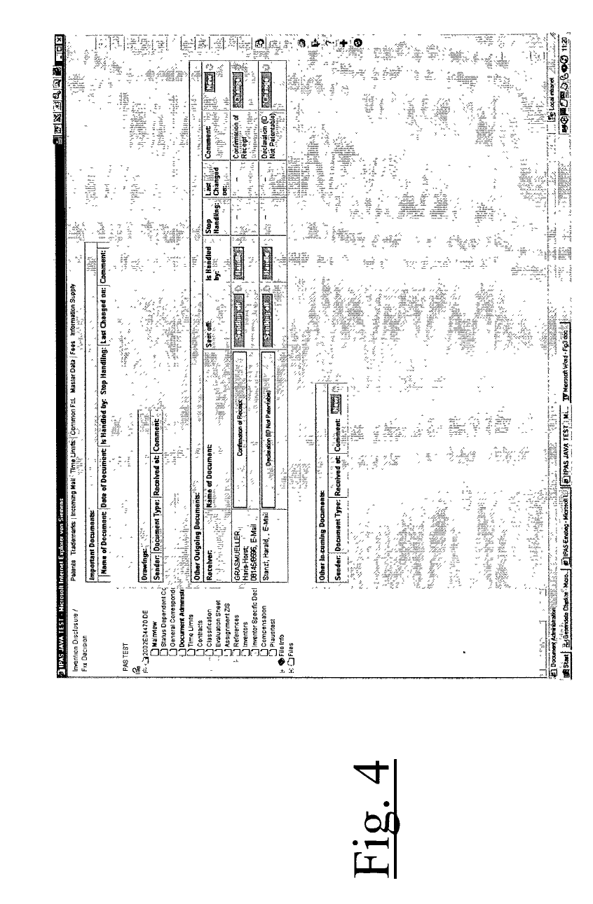

To continue, and with particular reference to the example shown in FIG. 4, as soon as the document has been created, the user receives a message and the document is displayed as a link. This may be provided by a specialized mask previously referred to as the document administration view. To be able to edit the document, the user selects the Edit button in the relevant row of the table. This releases the document to the current user for editing. The present invention further provides for support and plug-in applications to supporting applications, including word processor applications, such as, an additional toolbar displayed that lists the functions relating to the document presently displayed.

Of course, the present invention also provides for the creation and support of general correspondence which are not status dependent. The general functionality of the general correspondence is similar to the status-dependent correspondence, the difference being that normal events are not triggered by these documents. That is to say that normally events do not cause the general correspondence does not trigger events. Of course, there are exceptions where even general correspondence would trigger an event. Needless to say, rehashing the description for these documents would be prolific and a full disclosure thereof is simply deferred to the relevant sections regarding the status-dependent correspondence.

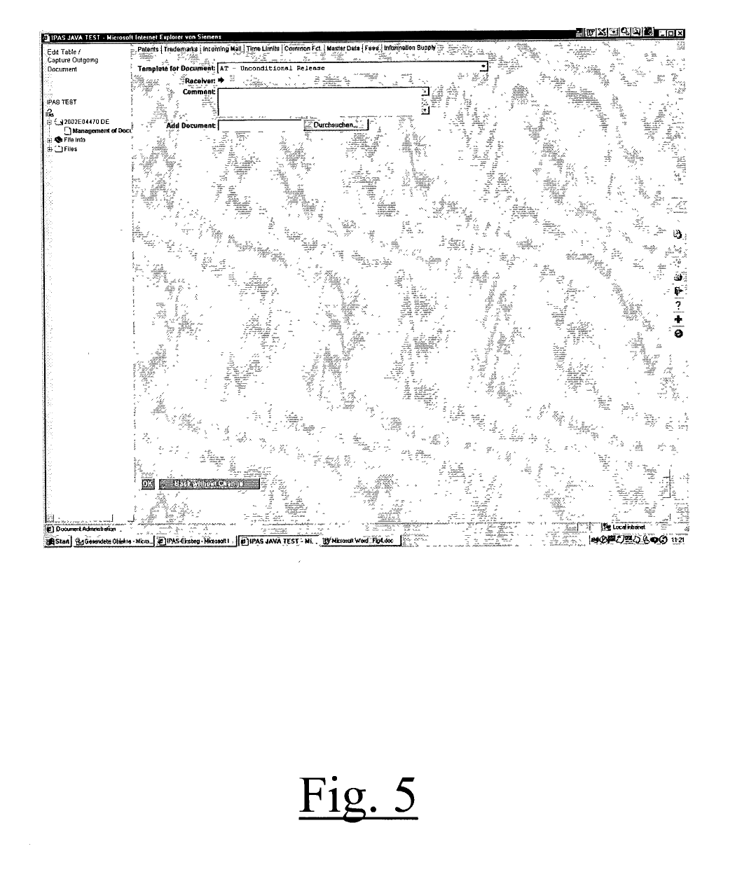

To continue, there is further provided the function of adding outgoing documents as exemplified by FIG. 5. Here, outgoing documents are imported into the IP administration system from external systems. The intermediate mask 500 shown is opened, which may be provided, for example, by the document administration view. This allows the user to import into the system a document that was created outside the system. There may also be provided a drop-down list that provides a list of selectable relevant document templates and add the document using action buttons. A document imported in this way is treated as if it had been created in the system.

Outgoing documents include the sending off of letters. Such is important in administration to advance the status of the case. In our patent example, it is important to send off such letters as the patent applications, responses to rejections, filing of assignment and declaration documents, information disclosure statements, filing fee transmittals, etc. When sending off a letter often time limits are set or deleted, respectively. Thus, it is necessary to mark a document as being sent off only when the letter is actually sent off.

It is important in several instances of IP administration to confirm that the sent letters are received. Thus, there is provided by the invention a data base an allocation document collecting main which collects expected document types to be received as confirmation from the sender. Thereby, there can be configured the expected return letters for the letters sent off. In our example, these anticipated documents are taken directly from the legal rules of the various jurisdictions.

Another way in which documents affect the administration of files is by the establishment of time limits. The purpose of time limits is to ensure that processes progress according to plan defined automatically by the invention. A time limit informs one or more users that action must be taken by a specific deadline regarding a specific file. Normally, time limits relate to a specific file, however, special exceptions are, of course, within the scope of the invention. An automatic time limit is triggered or cleared when a defined event occurs.

In the invention, there may be provided various defined events. An event could be the activation of a transaction, for example. A transaction is a broad concept within the invention covering the exchange between the corporate user and a third party. This could be, for example, related to payment, such as patent issue fees, maintenance fees, etc. Or, the transaction could be related to legal in nature, such as the formation of an agreement, or the proceedings of a litigation. Regarding documents, there is provided the sending out of a document based on a defined strategy set out in a template. This event is often employed for document filing of legal documents, such as the filing in the relevant receiving receptacle, such as a patent application. On the flip-side of document management, there is also provided the event to receipt of a document. The present invention, of course, is capable of receiving any type of document, although the particular invention disclosed are prepared documents of a defined type.

Normally, time limits are automatically set in the document template when the master template is instantiated for a particular document. Alternatively, the time limits can be set manually by the user. This could be provided by a special mask herein referred to as a time limits view or could be modified or cancelled in the same view.

Another means for activating events is with specialized functionality buttons. In essence, there is provided buttons that, when activated, by mouse for example, initiate a series of processes that carry out the advancement of the status of the file and instantiate other events. In the Java aspect of the invention, there is provided button objects, that, when activated, instantiate a version of the button and act as an application agent. Now, there will be provided a description of the various button functionality.

There are provided process mask buttons that are transaction buttons that save data entered into the database. This functionality button primarily has the function to save the entered data. However, the button also initiates events which trigger time limits and plausibility checks, as well as changes the status of the file. For example, when the button is triggered for entering the date of a critical time limit, such as a critical patent bar date, the time limit entered is saved in the document template for the relevant file. Also, the completion of an action causes, by activation of the process mask button, the corresponding event time limits to be removed.

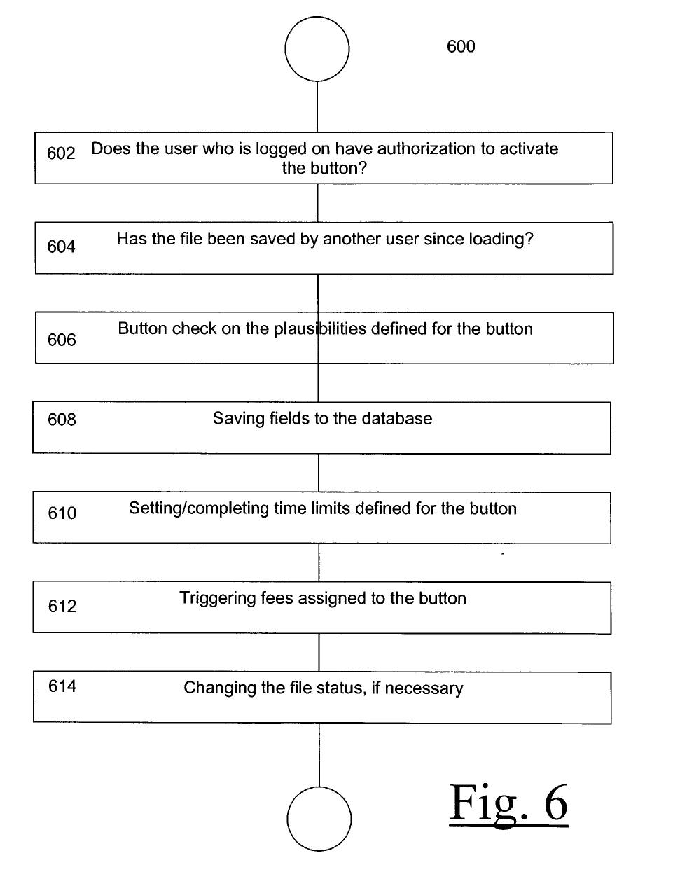

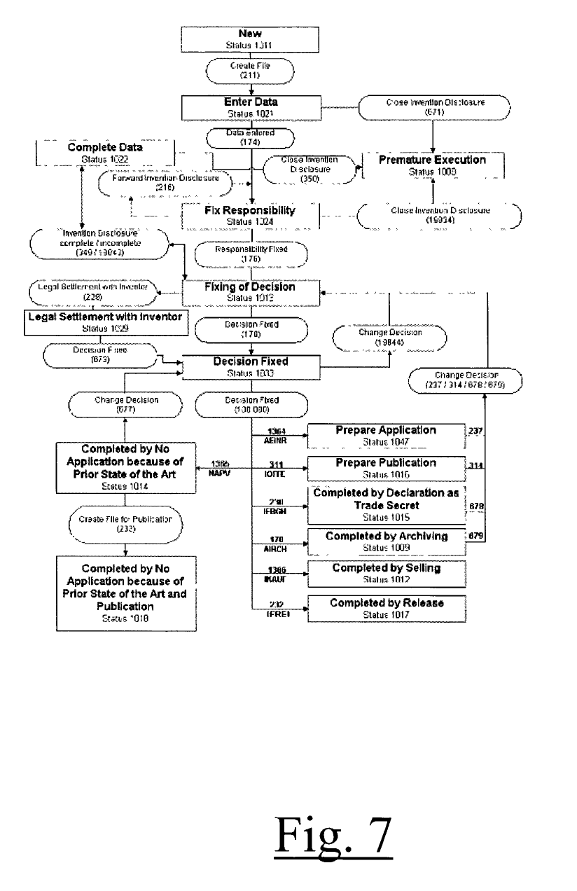

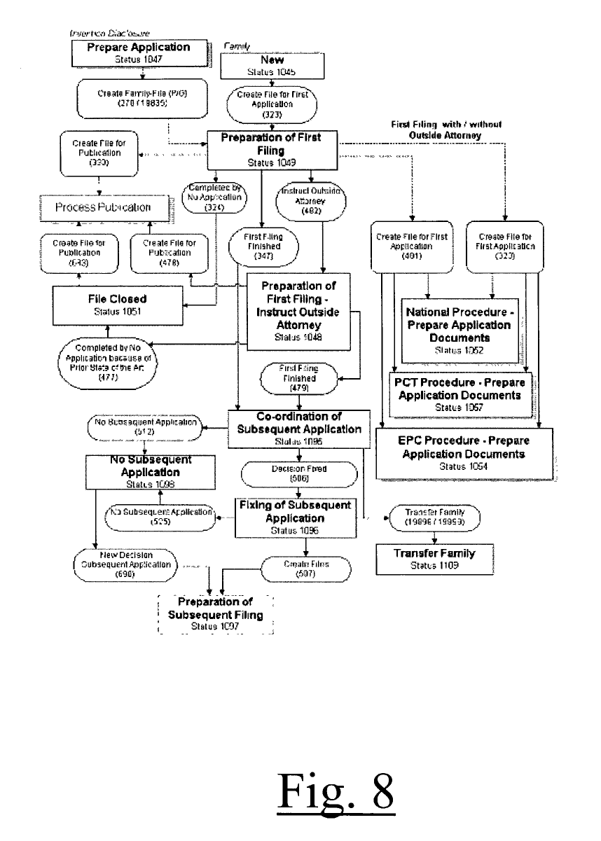

In FIG. 6, there is provided the steps 600 for accessing and manipulating documents using the present invention based on the user definition of a given user. Of course, the following steps are merely examples of the operation of the invention and one or more of the steps are within the scope of the invention. In addition, other steps not shown may be within the spirit and scope of the invention.

In step 602, the invention determines whether the user who is logged on has authorization to activate a particular button. In other words, when a transaction button is pressed the system checks whether the current user is entitled to do so, based on an assignment between user groups and transaction buttons. If not, the system issues an error message. Next, in step 604, the system determines whether the file has been saved by another user since loading. If a file is opened by different users at the same time, the system checks whether the file has been saved since it was loaded by another user. If not, the system issues an error message. In step 606, there is executed a button check on the plausibilities defined for the button. When a transaction button is pressed, the system checks whether all plausibility check preconditions defined for the button have been met. If not, the system issues an error message.

To continue, in step 608, the systems saves fields to the database. Thus, pressing the transaction button causes the data entered on the template to be saved to the database. In step 610, the system sets/completes time limits defined for the button. When a transaction button is pressed, the system checks whether the button has specified a trigger or completion function in the time limit triggers. In other words, the button defined in the time limit serves as a trigger or completion rule and causes an existing time limit to be deleted or a new time limit to be triggered. In step 612, there is triggered a fee(s) assigned to the button. That is, when a transaction button is pressed, the system checks whether the button appears as a fee trigger in the fee table and triggers assigned fees. In step 614, the system changes the file status, if necessary. Here, if the system has been configured so that pressing a button prompts a status change, the file status changes, after which the file is opened in the new status.

Now that the document management has been described, the operation of the invention will now be discussed with reference to FIGS. 7-13 which illustrate the document management features discussed selected and arranged into processes by which the document administration carries out IP administration. It will be appreciated that the processes described are examples and that other processes or modifications thereof are within the scope of the invention. Moreover, while particular areas of IP are exemplified, it will be appreciated that the invention covers all aspects of IP.

Before turning to the details of the individual process flows, it is worthwhile to discuss another unique feature of the invention regarding the manner in which the invention carries out the process flows. From the several flow process diagrams, it will be seen that the process flows are not carried out using traditional methodologies. In the traditional approach, process flows are simply carried out by providing a series of steps. By contrast, the present invention drives the process flows by document administration. To this end, there is provided predetermined statuses and events developed in advance by the invention. That is, there is provided a library of standardized programming blocks. As will be appreciated, this approach is in essence an object-oriented approach to carrying out administrative processes. With such an approach, rather than recreating the wheel with each process, there is provided a building block approach that allows the various processes to be carried out by mixing and matching these blocks for the various processes. Thus, the present invention will be described with reference to status' and decisions rather than as steps.

The building-block approach is particularly advantageous and novel in administration. More particularly, it is advantageous because this approach allows the ease of building new processes on the fly from the set administrative features. In the patent example, this is important, where the laws are changing constantly and new administrative processes must be created. And, it is often the case that the processes need to be modified. Thus, the present invention lends itself conveniently to the administrative work flow process.

The system, as will be appreciated from the process flows, incorporates a plurality of jurisdictions in a particular process flow. Thus, for example, the system takes account of unique laws, such as the provisional application in the U.S., as well as the procedures for perfecting the provisional, as well as processing a national procedure application for another jurisdiction, such as in Europe or Japan, for example.

Now turning to the process flow diagrams of FIGS. 7-15, there are provided examples of process flows for carrying out the administration of the IP portfolio. In FIG. 7, there is shown the process flow for obtaining an invention disclosure of an invention to be applied for patent. The system enters a new Status 1011 for the case which indicates for any action taken that the case requires input of significant data in order to set the appropriate triggering events based on the data. The decision 211 to create the file generates the internal reference number for the file, which in the preferred embodiment is a code developed from key indicators, such as the year the file was opened, the type of application, the number in the series of such applications and family information.

In addition, the system may instantiate the documents required according to the type of case from a Document Administration library and inserts the information automatically. Such a library would include, for example, all of the documents required by a particular patent office. In this status, if the information is not forthcoming, the system automatically requests the information in order to complete the opening of the new file.

In the enter data Status 1021, the information is entered. At this time, the system is programmed to prevent incongruencies in the data by, for example, allowing only the administrator to enter the administration. In the decision 174 the data is entered. In case that it is decided not to proceed, particularly because the required data is lacking, the decision 671 to close the invention is made and the system enters the case into the premature execution status 1006. In this status, the system archives the file and prevents the file from being further operated on.

To continue, the system enters the fix responsibility status 1024 for the file. In large international organizations, where a number of departments may be working on the file, responsibility tracking can be critical. In addition, it is often the case that various people within different departments perform a different function on the file. In these cases, it would be a disaster if multiple people were allowed to work on the file and, worse, if a file was left unassigned and went abandoned. While other schemes are within the scope of the invention, the system, for example, may employ a cost center person of responsibility (PIK) who is responsible for authorizing costs associated with the file, a primary person of responsibility (PIV) who is responsible for the substantive action to be taken on the file. In addition, there may be inventors listed who are responsible for reviewing the draft application that are fixed. Further, a cost center where the costs are charged to, which may be, for example, a business unit of a the corporation. As will be further clarified, the system triggers the responsible person at specified times depending on the type of action to be taken.

The system in decision 216 causes the invention disclosure to be forwarded to the appropriate responsible personnel, as indicated in the fix responsibility status 1024. At this point, if no responsible persons fixed then the invention disclosure is not able to be further processed and the system, despite prompting administration to fix responsible parties, closes the invention disclosure in decision 19834 and enters the status of premature execution 1006. After the responsibility is fixed, the system enters the fixing decision status 1013 which determines what action is to be taken depending on the type of application and determines whether the invention disclosure should be furthered or not. If it is determined that the invention disclosure is definitively to go forward, then the decision that the invention is complete 349. Otherwise, the invention disclosure is set as incomplete in decision 19843 and resent to status 1022 where the system prompts the personnel to complete the data.

As indicated, a novel point of the invention is that it takes into account a plurality of legal jurisdictions at the same time. It is an administrative package for global administration support. For example, in some countries such as Germany, there is required by law to compensate the inventors or allow them to process the patent application on their own. To account for these procedures, the system in status 1029 sets the file in a legal settlement mode that sets triggering events and alerts in decision 229 to the personnel to settle with the inventor within the legally proscribed time limits. When a legal settlement with the inventors has been reached, the system enters the legal decision as a fixed status 673 regarding the legal settlement. Of course, the system also accounts for changes in the decisions and redirects the process flow via decision 19844 when a change of decision is to be made.

Then, the system enters into a series of statuses that carry out the substantive processing of the invention disclosure. In the first status, the system enters the prepare application status 1047 where triggering events and alerts are set to process the preparation of the application based on the invention disclosure and the system prepares custom tailored documents for filing based on the information entered in decision 174. Status 1016 handles a unique situation in Germany when it is decided to not proceed to file with an invention. In this case, the invention is instead published in order to provide a special defense provided for in Germany. Of course, other jurisdictions have similar rules, but the German patent laws provide for this specific defense and the system provides for this in status 1016.

It will be instantly appreciated that the present invention is a versatile administration tool and can, of course, be implemented for other business applications, including any of the day to day administration activities, such as sales, marketing, business planning, accounting, supply chain, etc. Thus, the present invention can be thought of as a business administration system.

It is also the case that the application may be completed in other ways besides securing by patent. As indicated, the system is a total administration package and supports, not only patent protection, but all types of IP. In the case of status 1015, the invention disclosure is decided to be kept as a trade secret. In this instance, the system secures the file so that it is not allowed to be sent out or viewed by third parties in order to maintain the secrecy of the subject matter. In addition, the system automatically alerts the personnel identified in status 1024 that the case is a trade secret and not to disclose to the public.

Another manner in which case the case is disposed is by deciding that the case becomes stale because of, for example, lack of interest in the market. In this case, the invention disclosure is archived in status 1009 by the system in order to provide evidentiary proof of the invention in case of jurisdictions which provide protection by means of inventorship such as in the U.S. under the American Inventorship Protection Act.

The system also accounts for third party transactions of the IP. In status 1012, for example, the system enters a status for the file that indicates that the corresponding invention disclosure is sold to a third party. In this case, the system automatically alerts the appropriate personnel to transfer the case to the third party and records the transaction. The terms of the agreement are recorded, including, whether the third party takes over the prosecution of the case. In the other event, the system drives the prosecution in order to fulfill the requirements of the agreement.

In the case of status 1017, the subject matter of the invention is deemed to be the ownership of the inventors and is no longer pursued by the company. In this instance, the system indicates that invention disclosure is completed by release and records the agreement in order to evidence that fact. It will be appreciated that this and other contracts that are recorded are recognized as evidentiary proof in certain jurisdictions of a contract. The system is designed in this manner in order to provide an automated document retention process with this particular evidentiary function in mind.

The system also takes into account that the file may be discontinued by the state of the prior art in status 1014. In this instance, the system decides to create a file for publishing the invention 233 in order to prevent competitors from obtaining similar patents as a means of protection of the company through publication. The system then enters the completed mode in status 1018.

With reference to FIG. 8, the process flow for the preparation for a patent application will be described. As before, the system enters the new and create statuses 1045 and 323. After which, the system enters the case into a preparation of first filing status 1049 which generates the fundamental triggering events and time alerts appropriate for moving the preparation of the application forward. In decision 323, for example, the system automatically generates a file for first application, by instantiating a generic application document from the document administration database and importing the information from the master template developed during the invention disclosure process flow. In the case that the invention disclosure was first prepared, rather than from a family of applications, the system initiates the process of preparing the application from status 1047 and create file status 270. It shall be appreciated that the system takes into account the entire administration process of the application in this manner by distinguishing between cases that originate from invention disclosures and those that arise from patent families.

The system, as already described, is a complete administration package. It takes account, for example, of whether the case is sent to an outside attorney with instruction as in statuses 482, 1048 and 481. In this sub-process, the documents are transferred to the outside attorneys with specific instructions how to carry out the preparation of the application. This is in contrast to the previous case, where the case is either prepared in-house or sent outside with no instructions. In the present case, correspondence and appropriate directions, such as protocol for contacting inventors, the system set alerts for the administration and in-house counsel to take action.

As indicated, the system accounts for multiple jurisdictions simultaneously. To continue, the system enters the case into the national procedure preparation status 1052, wherein the appropriate documents and procedures for a particular jurisdiction are automatically generated by the system. Contrast this with status 1057 for preparing a PCT application, where different parameters are required to be set forth, such as different correspondence address for the PCT office, setting of different time limits, such as requests for examination, which do not occur necessarily in national jurisdictions. In the preparation of the EPC patent application in status 1054, the system sets for the documents and procedures for appropriate EPC filing. The details of these various types of filings will be discussed more thoroughly below. For now, the system is in the preparation mode of creating the application.

Once the first filing preparation is finished, as in statuses 347 and 479, the system addresses the issue whether a subsequent application is to be pursued in status 1095. In decision 508, a time alert is set to prompt the administrator or responsible PIK to determine whether to file subsequent cases. When the decision has been made and entered in status 1096, there is either a subsequent file created in decision 507 and operation is forwarded to preparation of subsequent filing in status 1097, or there is no subsequent filing decided as in decision 525, which is recorded in status 1098. Of course, the decision not to file a subsequent application may be changed in decision 690, in which case the subsequent filing is entered into as before in status 1097.

As already indicated, the system also provides for publication of the application for the various jurisdictions in which publication is necessary. In statuses 330, 683 and 478, a file is created for publication. In other cases, it is advantageous to publish the invention, such as for defensive purposes when, for example, it is decided in decision 324 to not file an application and the file is closed in status 1051.

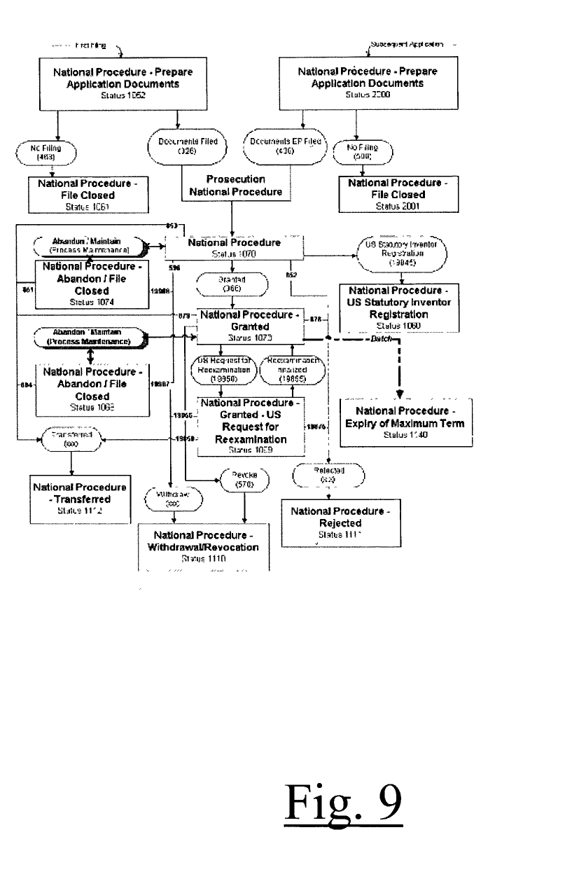

Now, with reference to FIG. 9, the specifics of prosecuting a national procedure application are described. In the instance where the national procedure is based on a subsequent filing, the system takes this into account in status 2000 and prepares for creating the reference number from the parent case in order to preserve the history of a family of cases. Otherwise, the first filing begins from status 1052. In the case that it is decided to not file the application, in decision 468 or 600, national procedure is closed in statuses 1061 and 2001, respectively. To proceed, the system advances the status of an active case to 375 or 438, which obtain relevant documents, such as the EP filed documents in status 438, in order to generate the correct documents and time alerts and triggering events.

In the national procedure status 1070, it is decided to proceed with filing the patent application under national procedure and set the triggering events and time alerts according to the national laws of the jurisdiction in which the patent application is being filed. As already indicated, the system takes account of different jurisdictions and sets the precise time alerts and triggering events for that particular jurisdiction. Further, there is provided in status 1070 setting all of the triggering events and time alerts for prosecution for the particular jurisdiction, such as timing for answering official patent office correspondence received through document administration. For example, when the patent office rejects an application, the triggering events for responding are set and the rejected status 1111 is set.

In addition, the system takes care of the local aspects of prosecution for the particular jurisdictions. For example, there is provided US statutory inventor registration in decision 19846 and recorded in status 1060.

When the application is granted in decision 368, wherein the formal issue notification, for example, is received from the official patent office, the received document is processed and recorded by the system. The alerts for paying the official fee or other action to be taken to complete the granting of the patent are automatically set by the system.

The system also tracks post-issuance of a patent. In the U.S., for example, reexamination is provided for under the patent laws. The system accounts for the local rules of the various jurisdictions and, for example, sets the triggering events and time alerts for the reexamination request procedures and confirmation in decision 19850, 19855. It shall be appreciated that reexamination is unique to the U.S. and is not offered as an option by the system. When the patent office confirms granting the reexamination request, this is recorded in status 1069. In case that the reexamination request is rejected, the system provides for recording this rejection.

As mentioned, the system presents options to the user depending on the user's status, the type of file and the jurisdiction. This is part of what is meant in the application by document administration. It is important to emphasize this point. The system actively regulates what options are available depending on the status of the case. In this manner, the system tends to avoid errors, while at the same time, adjusting for all types of situations and jurisdictions. For example, in the last process discussed, reexamination is not offered in jurisdictions other than the U.S. In this case, the system does not offer the option for cases that are filed outside the U.S. On the other hand, even if the application has relative applications in other jurisdictions, the user will not see the reexamination option for the U.S. filing.

In the situation that the application is finally rejected, i.e., revoked, the situation is recorded in decision 570. When the application is withdrawn, such as from issue, this is also recorded by the system and triggering events for responding to the withdrawal, such as submitting an IDS, are set and the status enters 1110.

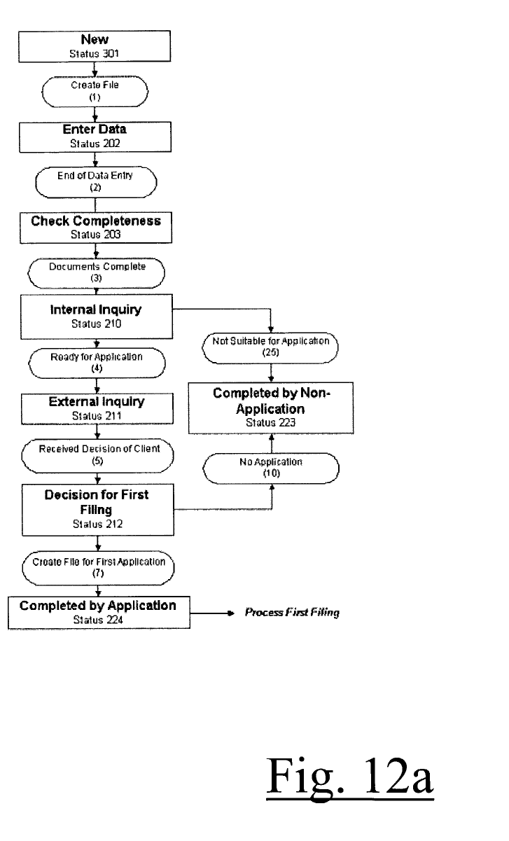

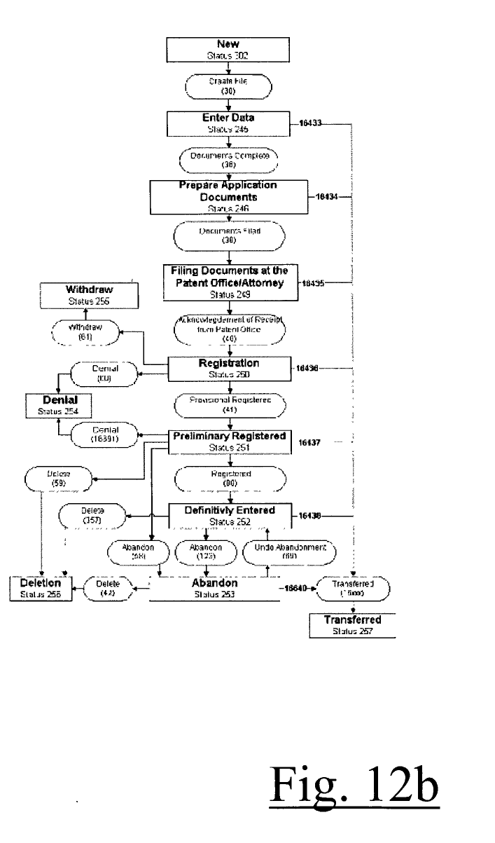

The system also takes account for abandonment procedures and maintenance procedures. Maintenance, which can be complex, particularly with a plurality of jurisdictions is handled by the system and will be discussed in more detail in FIG. 12. In any event, the case is closed in status 1068 when it is abandoned. In the case that the file is disposed in another way, such as transference to another company, the system generates the documents to transfer the file to the purchasing company and sets the status in 1112 in order to indicate that the new company is handling the prosecution of the case and that the present company should not take further action.

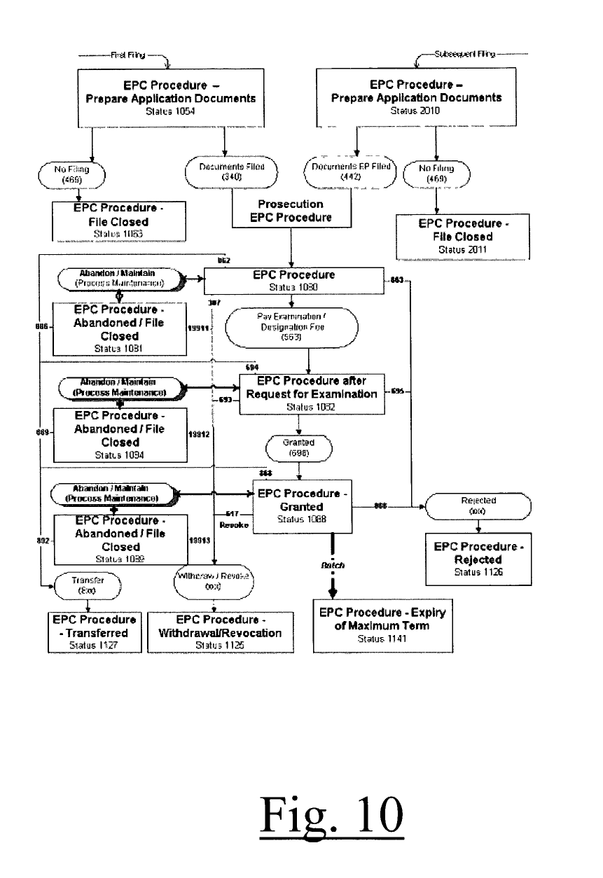

As indicated, the system handles a plurality of jurisdictions. More than that, there is provided by the system a relationship, or interaction, between the handling of the plurality of jurisdictions. In FIG. 10, for example, there is provided an EPC patent application preparation and filing process. Where the EPC case is filed from a family, such as in status 2010, there is a special procedure for setting up the EPC file and opening the documents for EPC filing based on the previous documents filed for the related cases in decision 442. In the EPC case, for example, the internal reference number is generated using the series number of the family file, the year of opening the EPC file and an indicator indicating that the EPC file is prepared for the EPO. Otherwise, when the EPC case is generated as a new filing, i.e., with no related family of cases, (Status 1054) then an all new internal reference number is generated in decision 340. In the case where it is later re-decided to not file the EPC file, the system closes the file in decisions 469, and places the file in the closed file status (1063, 2011, respectively).

Although, the EPC filing process (FIG. 10) appears to be similar to the National Process (FIG. 9), closer inspection will reveal that the EPC filing process is specialized for handling specific EPC procedures, thereby fulfilling the promise of the invention to handle a plurality of jurisdictions. For example, after the EPC procedure in status 1080 is initiated, the system prompts the responsible personnel in decision 563 to pay the examination fee. For this, the system assists in the preparation of the documents to request examination and pay the fee. Under EPC rules, the procedure changes after the request is made and, accordingly, the system in status 1082 sets the triggering events and time alerts for handling the EPC process. For example, during prosecution, when the EPC case is rejected during the search and preliminary examination (status 1126), the prior art in the rejection is catalogued using alphabetic characters. When the prior art character is a certain value, the system may be set to generate an automatic information disclosure statement for other jurisdictions where related cases are being applied for patent.

In addition, when the EPC application is granted, the system prepares the documents for paying the granting fee and generates automatically the documents for transmittal of the payment. The system sets the status of the case to 1088 to indicate that the case is in the granting stage and sets the time alerts according to the EPC rules for alerting the responsible personnel to timely pay the granting fee.

The system, similar to the national situation, handles abandonment of the EPC case at different times throughout the prosecution of the case. For example, there may be a decision to abandon the case during initial preparation and filing in decision 886 and set as the status in 1081. There may also be the decision to abandon after reading the examination report in status 1084 due to, for example, a realization of the futility of proceeding based on the known art. The case may be pulled from grant and placed in an abandoned status 1089, such as when it is decided for strategic market advantages to not have a patent. In each of these instances, the system makes note of the various situations under which the case is abandoned because it affects the manner in which the system handles the abandonment. For example, in cases where the abandonment is due to prior art, then the system may automatically generate a publication procedure. On the other hand, if it is deemed a trade secret, the system will place the invention in confidentiality if possible to do so before the 18 month automatic publication by the EPO.

The system is a full administration package and handles all aspects of prosecution by the EPO. In case that the case is transferred in decision 800, the case is set to status 1127 and the contract of sale will determine how the system handles the prosecution thereon. In the case of withdrawal or revocation of the case, the system sets the status to 1125 which is similarly described in the prior case. There are also special procedures for the expiry of the maximum term in the EPC as set forth in status 1141 that the system handles.

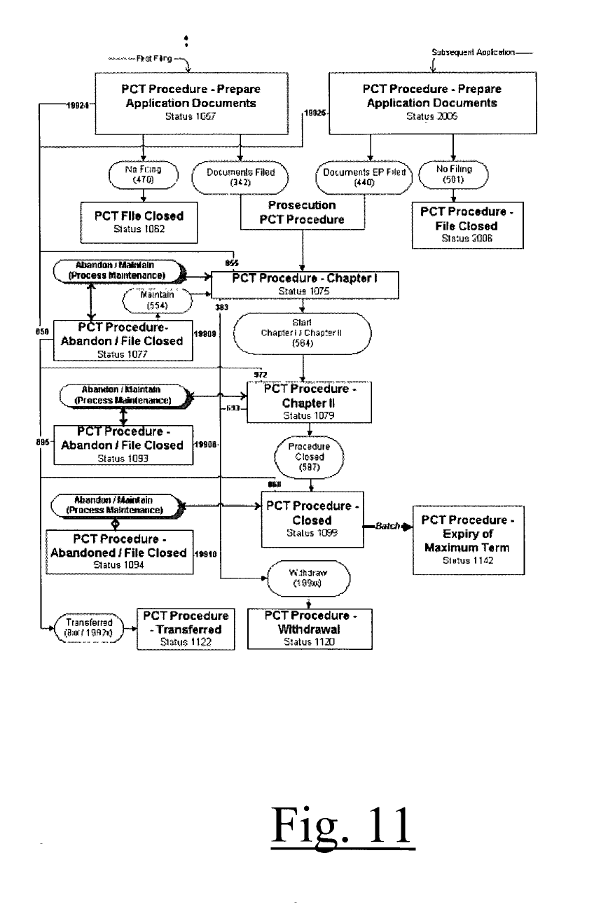

In the PCT process flow of FIG. 11, there is an example of how the system processes PCT applications for filing and prosecution. Similar to the previous examples, there is provided a distinction amongst opening a new file for filing as in status 1057 or a filing related to a family as in status 2005. As before, documents are generated with the assistance of automated file preparation provided in the document administration of the system in decisions 342 and 440. In the case of deciding not to file, as in decisions 470 and 501, the case is prematurely decided not to file an application and this is recorded in status 1062 and 2006, respectively.

The filing and prosecution procedure of PCT begins in status 1075. Unlike the previous instances, the system provides for the special procedures of the PCT. For example, Chapter I PCT is prepared for in decision 564 and the documents and time alerts for driving Chapter I, such as preparation of the filing documents and selection of member countries, are automatically prepared. For example, the system will poll the responsible personnel in the relevant jurisdictions to determine whether the PCT should be applied for in those countries. Chapter II procedure in provided for in status 1079. Chapter II typically requires the claims to be in satisfactory form and formal drawings and the system drives the process for obtaining the requirements and filing them.

The abandonment process is similar in structure to the previous cases, but it must be noted that the details will differ because the PCT has particular rules concerning abandonment. In any event, abandonment may occur during chapter I in status 1077 or during Chapter II in status 1093. However, abandonment never occurs in PCT in the same meaning as in national prosecution. To account for a case that lapses in the PCT, the system provides a special status 1094 that flags that no follow up cases in the national jurisdictions were filed. Of course, the decision to maintain the case may be set in decision 554. The procedure is closed decision 587 and set to status 1099.

As in the EPC, the PCT case may exceed the maximum expiry term in status 1142, such as going beyond the 30 months after filing without filing. In this case, the system takes special procedures because the file was closed due to lack of action, intentional or otherwise, which resulted in the non-filing of the case. As before, the case may be withdrawn, as in decision 199 and set in status 1120 or the case may be transferred in decision 1992 and set instatus 1122.

It shall be appreciated that the invention is not merely a patent filing system, but rather incorporates administering all IP, including Trademarks and Trade Secrets. It has already been discussed that the process takes account of preserving inventions for trade secret. It shall be appreciated from FIG. 12a that the system handles the administration of the trademark applications while FIG. 12b regards the preparation and filing process.

As indicated, FIG. 12a is directed to the administration process of a trademark. It shall be appreciated that this aspect of the system is not driven by application laws of any jurisdiction, but is an administrative function provided by the system that addresses the unique administration issues that arise in corporations over trademarks. After the file is created in status 301 and decision 1, for example, using a series number and a character code to indicate that the case relates to a trademark, the trademark data, such as the trademark name and the good and services description are entered at the prompting of status 202.

Fixed entry is completed in decision 2 and there is a completedness check in status 203. Unlike patent applications, trademarks require such particulars before filing, such as intended date of use or first date of use and samples of the products or services, as well as descriptions thereof. These particulars are required to be completed before filing.

As mentioned, the system addresses particular administration issues of trademark preparation and registration, including, for example, performing an internal inquiry of whether the trademark should be applied for registration. Trademarks, in some ways, relate closer to the business, than patents, and may require a strategic business decision whether the trademark should be applied for registration. Perhaps, the product for which the trademark is being applied will be discontinued. Or, perhaps, the trademark is already applied for by another division or business partner. If not, the decision not to file the application is decided in decision 25 and recorded in status 223. Otherwise, the system advances to the next step, ready for application 4, and submits an external inquiry, such as a search report in status 211.

Once a decision to proceed to file is determined after approval at the internal level and after reviewing the search report, for example, the system prepares for filing in status 212. In decision 7, the system prepares the documents from the entered data and from documents stored in the document administration database. If, however, after reviewing the search report, the decision is not to file, then the system sets the decision in 10 not to file an application and the status proceeds to 223. To continue, the application is created and filed in decision 7 and the system records that the trademark application is completed for filing.

Now that the administration of the trademark has been dealt with by the system, the process flow for filing the application will now be addressed by FIG. 12b. As before, the system generates a new file in status 302 and creates it in decision 30, if the file has not been already opened. If the data was not entered previously, the data is entered in status 245 and completed in decision 36. Using documents stored in the system database, the system automatically generates the forms by importing the data entered in decision 36 and filed in decision 38 and recorded in status 249. The receipt of the trademark application acknowledgement is recorded in decision 40.

When the trademark office accepts registration, the system enters status 250 for the case. Otherwise, if the trademark is denied in decision 60, procedures for addressing the denial in decision 254 is provided. If it is decided that the denial warrants withdrawal of the application such as in decision 51 and set by the status 255.

The system also accounts for preliminary registration in status 251, as is provided in certain jurisdictions. For example, in the U.S. an intent-to-use registration may be applied for and obtained. In this instance, the system sets alerts for following up and obtaining the appropriate declarations that the trademark is in use in commerce as required by the U.S. Trademark Office within the set time limits. In case that the preliminary registration is denied, for example, for lack of completedness of the goods and services, etc., the decision is recorded in 15591 and addressed in status 254. At this time, it will be decided whether to respond to the denial in order to overcome the denial.

If the application is finally approved, it is recorded as registered in decision 80 and definitively registered as attested in status 252. At any time, the owner of the registered trademark may cancel registration and this is taken care of in decisions 59 and 357, as recorded in status 256. As well, the case may be abandoned for lack of attention to the case, despite the alerts set by the system, and the decision to abandon the case is set in decision 50, 123 and the status is set to 253. If the case is revived from abandonment in decision 69, the trademark is restored to registration and the status is reset to 252. As before, the trademark may be sold, or transferred, as decided by decision 16xxx and set in status 257.

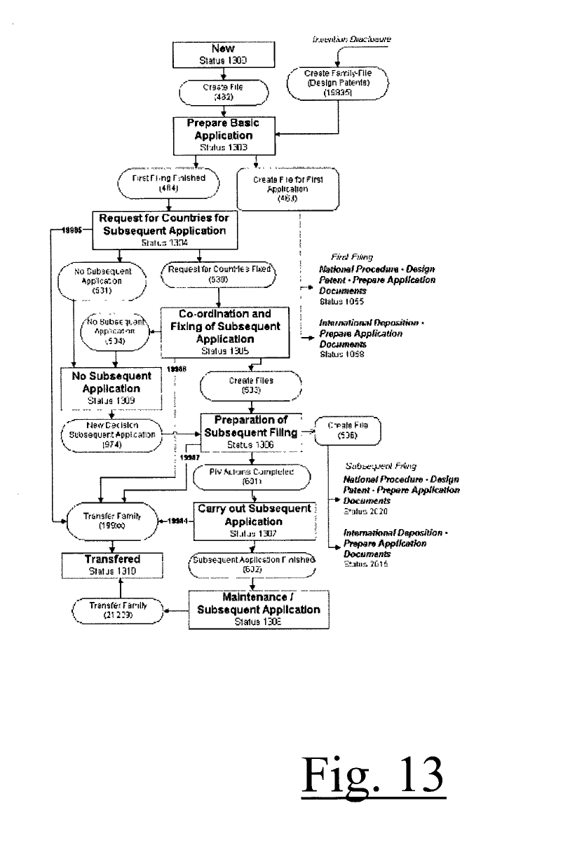

The invention is a full administration system. In terms of IP, for example, the system also provides handling of design patents. This will be appreciated from FIG. 13. As before, a new case is created in status 1300 and carried out in decision 452. In the U.S., the design application is relatively formalistic and can be compiled using basic information from the master template as driven by status 1303. In the case where the design is based on a patent application, the information may be imported from the related family file. This may include, for example, importing the significant figure from a related PCT file.

In the international community, design patents have a variety of additional procedures that must be complied with and FIG. 13 takes into account the requirements of the various jurisdictions. For example, there is a distinction made in some jurisdictions outside the U.S. between first filing a design patent application, such as in decision 463, and where the design application is based on a previous case in decision 464. This distinction reflects the principle of some countries that design patents are more related to copyright.

Within the status of creating a first file for a design patent application, there is a distinction made between national procedure filing and for international deposition. In the national procedure 1055, the system sets the procedure for filing on the national level according to the specific national requirements. In status 1056, certain international treaties, require a complex set of procedures that coordinate subsequent filings of design patents. Notably the PCT does not recognize design applications. Of course, the decision to file subsequent applications may be re-instated in decision 974.

In status 1304, the system enters the status 1304 for requesting countries for subsequent application. In decision 531, it is determined that no subsequent application is requested and the status of no subsequent application 1309 is entered. Otherwise, a request for countries is fixed in decision 530 and the system enters a status for coordinating and fixing the subsequent application in status 1305. Based upon which, the system creates the subsequent files in decision 533 and prepares for subsequent filing in status 1305 and creates the file in decision 535. Again, the filing is divided between either national filing or international in statuses 2020 or 2015, respectively. The subsequent application is completed in decision 602.

As a complete administration system, the invention also provides for post-grant handling of the design patent. In status 1306, maintenance of the design, when granted, is provided for. If the design patent or application is transferred in decision 199, the system enters the status 1310. The same may happen after the patent is granted, such as in decision 21239, which provides for transfer.

While the present invention has been described in terms of an IP administration system, it will be instantly appreciated that the present invention is, in essence, a business administration tool. The invention is a versatile administration tool and can, of course, be implemented for other business applications, including any of the day to day administration activities, such as sales, marketing, business planning, accounting, supply chain, etc. Thus, the present invention can be thought of as a business administration system.

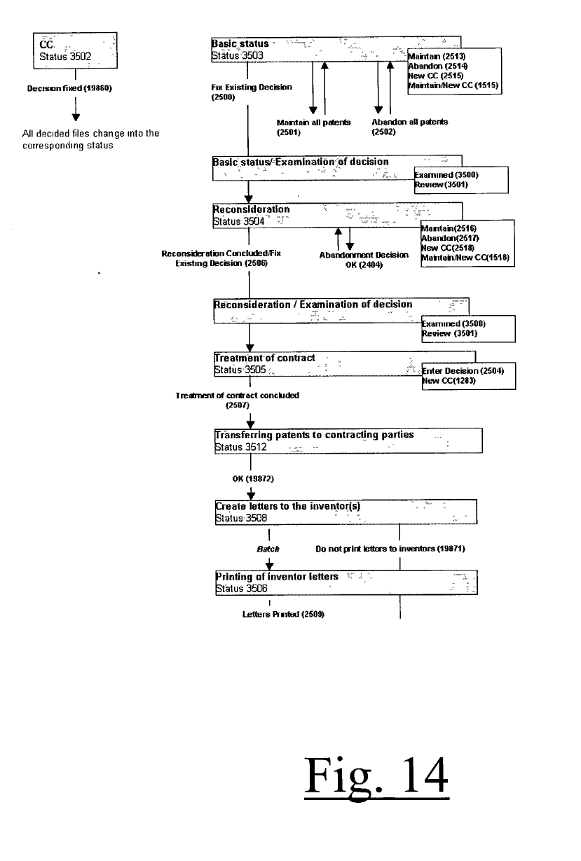

For example, there is provided in FIG. 14 the administration of maintenance fees. As will be appreciated, the system of the invention provides for the maintenance in a plurality of jurisdictions through document administration. The system begins from a basic status 3503 where, for example, a case is issued as a patent. At this time, administrative decisions must be made, for example, of whether the business deems the patent worthwhile to pay the issue fee. In software cases, for example, it is not uncommon for a patent owner to allow the patent to lapse because software technology typically becomes obsolete more quickly than other technologies. Thus, the decision is made to maintain (status 2513) or abandon (2514) the case.

It shall be appreciated that the invention is a true administration package as it administrates for entire portfolios. That is, the invention maintains a particular case in light of the total circumstances, including other cases. This is contrast to maintaining a single case. For example, the invention decides in the same process flow whether to maintain or abandon related or corresponding cases (2515 or 1515). In one aspect, the decision to maintain or abandon is based on the theory that the decision of a business to not pursue a product line in a particular country is related to the decision for corresponding cases in other countries. This is illustrated by the all or nothing approach of statuses 2504 and 2502. Of course, it is also within the invention to maintain some cases while abandoning other related cases. It is possible that the status of only certain selected corresponding files are set to lapse as in status 19860.

Because maintenance decisions are final and it is often difficult, if not impossible in some countries, to revive a lapsed case, the system provides for an examination of the decision in status 3500 whereby the appropriate must approve the patent to lapse after a review in status 3501. There is also provided a back up check in status 3504, whereby an administrator or supervisor confirms the decision to lapse or maintain. If it is concluded that the case(s) is to be allowed to lapse, then the decision is fixed in status 2506.

As indicated, the invention is a complete administration system. In status 3505, the system provides for the handling of the case in regard to a third party contract. Thus, for example, if a product line or business is sold to a third party, the corresponding patents, and responsibility to pay the maintenance, may be transferred to the new company depending on the terms of the contract. As already stated, the system records the terms of the contract as a status of the particular case. In some cases, the patent maintenance responsibility remains with the patentee, for example, where the patentee sells only right to use in the patent. If it is indeed agreed to transfer the responsibility of maintaining the patent, then the decision is fixed by assigning the status 2507 to the case and the patent(s) is transferred to the third party in status 3512.

The administration system further provides for the alerting of the inventors in status 3508. In some jurisdictions, for example, the government requires the company to compensate the inventor(s) according to a fixed remuneration scheme. If the company desires to abandon the case, for example, some countries require the company to allow the inventor to take over the funding of the case. Thus, there is provided the option to alert the inventors as to the abandonment of the invention. In other instances, perhaps due to the contract with the inventor or the jurisdiction, it may be decided to forego informing the inventors as in status 19871. In status 3506, it is decided finally to inform the inventors and decision 2509 causes the system to generate the letters to the inventors. It shall be appreciated that the above scheme is oriented around the business of the company, that is, the business leaders drive the decision process whether to maintain the patent. This demonstrates that the invention is an administration system.

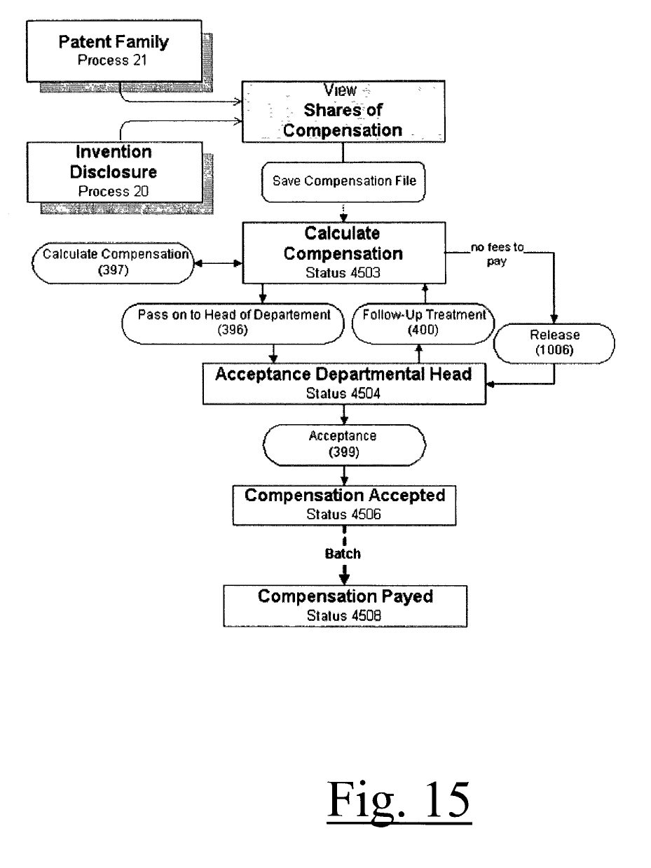

The system further provides a means for compensating inventors as shown in FIG. 15. Again, this demonstrates the administration aspect of the invention. It shall be appreciated as well that the invention as the ability to administrate a case for a plurality of jurisdictions as illustrated by the figure. It is first determined, whether compensation is to be awarded at the invention disclosure stage, as in status 20, or on a patent family basis (status 21). Then, the shares, that is the percentage ownership of each inventor in the invention, are determined from the inventors and saved in the system database. Based on this information, the system automatically calculates, according to the applicable laws, and/or internal corporate policy, the compensation owed to each inventor in status 4503 and as carried out by decision 397. If it is determined that the company is under full release of compensation, then the system in decision 1006 releases the company from compensation.

The calculation for compensation is then to the administrator or supervisor in status 4504 and approved (or not) in decision 399. Further evidence that the invention is an administration system, rather than a simple algorithm that mirrors laws. In some jurisdictions, the inventor must agree to the compensation and, once compensation is agreed upon, the system sets the status in 4506 and directs the responsible personnel to pay the compensation in status 4508. Of course, the system may also automatically compensate the inventor(s) through known automatic wiring of check cutting programs.

As indicated, the invention is a global administration system. This will be appreciated from the process flows of the several figures that incorporate schemes that account for the laws of various jurisdictions within the same process flow. More broadly, the invention covers an administration system, which is not only applicable to the IP field, as demonstrated by the examples above, but may be applied to any administration of a company.

1. A method for administrating a global intellectual property (IP) portfolio through document administration, the IP portfolio comprising at least one file having a document that is being processed, or prepared for processing, for global filing, global defined as a plurality of country jurisdictions in the world, in order to advance the file in a particular jurisdiction, the method comprising the steps of:
generating a set of statuses that each define at least one action designed to advance the file in said particular jurisdiction;
developing a process flow that incorporates, as elements, statuses from said set relevant to a plurality of said jurisdictions in such a manner that is designed to accomplish a procedure codified by said jurisdictions to advance the file in said particular jurisdiction; and
assigning a status from the set of statuses for said file according to the process flow, wherein the document is administered in accordance with the assigned status, thereby administrating the global IP portfolio through document administration.

2. The method of claim 1, wherein the process flow defines a relationship between the plurality of jurisdictions.

3. The method of claim 1, further comprising the step of coordinating action in offices in various jurisdictions.

4. The method of claim 1, wherein each status sets a triggering event that causes the processor to activate an operation on the file that advances the file in said particular jurisdiction.

5. The method of claim 1, wherein each status sets an alert.

6. The method of claim 1, wherein the statuses include administrative statuses that trigger administrative events.

7. The method of claim 1, further comprising the step of creating a template indicating the importance of the file and responsible persons for the file.

8. The method of claim 1, further comprising the step of assigning document types to the documents which dictate the type of process flow and status that is applicable to the document.

9. The method of claim 1, further comprising the step of coordinating efforts between offices by identifying a responsible coordinator in one of said offices and a responsible person for carrying out substantive work on the file as directed by the triggering events.

10. The method of claim 9, further comprising the step of providing news and legal resources forum to the various legal offices.

11. The method of claim 1, further comprising the step of providing pre-generated documents and importing information into the pre-generated documents.

12. The method of claim 1, wherein the processes process the file for patent prosecution.

13. The method of claim 12, wherein one of the process flows provides invention disclosure generation.

14. The method of claim 13, wherein one of the process flows provides application preparation and filing.

15. The method of claim 12, wherein one of the process flows is directed to granting of the file.

16. The method of claim 12, wherein one of the process flows is directed to post grant prosecution.

17. The method of claim 1, wherein one of the process flows provides automatic maintenance fee administration, including approval and confirmation of approval and automatic payment upon confirmation.

18. The method of claim 17, wherein a predetermined status relates the corresponding files in the plurality of jurisdictions based on business decisions to determine which files are allowed to lapse, wherein a business decision is based on a market condition.

19. The method of claim 1, further comprising automatic generation and tracking of incoming and outgoing correspondence.

20. The method of claim 1, wherein one of the process flows is directed to compensation for inventors.

21. The method of claim 1, wherein the process flows incorporate business administration, the business administration comprising action taken on the file other than required by jurisdictional laws.

22. The method of claim 1, wherein one of the process flows provides formation of third party contracts and transfer of assets.

23. The method of claim 1, further comprising the step of maintaining privileged documents visible to authorized personnel in order to prevent publication of the file to an outside party.

24. A computer-readable product for driving a computer processor according to instructions that carry out the steps according to claim 1.

25. A global intellectual property (IP) portfolio administration apparatus for managing a file through document administration, the IP portfolio comprising at least one file having a document that is being processed, or prepared for processing, for global filing, global defined as a plurality of country jurisdictions in the world, in order to advance the file in a particular jurisdiction, the apparatus comprising:
a set of statuses that each define at least one action designed to advance the file in said particular jurisdiction;
a process flow that incorporates, as elements, statuses from said set relevant to a plurality of said jurisdictions in such a manner that is designed to accomplish a procedure codified by said jurisdictions to advance the file in said particular jurisdiction; and
a program that assigns a status from the set of statuses for said file according to the process flow, wherein the document is administered in accordance with the assigned status, thereby administrating the global IP portfolio through document administration.

26. The apparatus of claim 25, wherein the process flow defines a relationship between the plurality of jurisdictions.

27. The apparatus of claim 25, wherein each status sets a triggering event that causes the processor to activate an operation on the file that advances the file in said particular jurisdiction.

28. The apparatus of claim 25, wherein each status sets an alert that causes the processor to alert a responsible person to take a particular action on the file that advances the file in said particular jurisdiction in accordance with the process flow.

29. The apparatus of claim 25, wherein the process flow provides patent prosecution.

30. The apparatus of claim 25, wherein the process flow provides invention disclosure generation.

31. The apparatus of claim 25, wherein the process flow prepares and files an application.

32. The apparatus of claim 25, wherein the process flow provides granting of the file in the particular jurisdiction.

33. The apparatus of claim 25, wherein the process flow provides automatic maintenance fee administration, including approval and confirmation of approval and automatic payment upon confirmation.

34. The apparatus of claim 25, wherein the process flow provides for compensation of inventors.

35. The apparatus of claim 25, wherein the process flow includes business administration, the business administration comprising action taken on the file other than required by jurisdictional laws.

36. The apparatus of claim 25, wherein the process flow provides for third party contract formation and transfer of assets.
